(19) United States
(12) Patent Application Publication
(10) Pub. No.: US 2018/0069385 A1
(43) Pub. Date: Mar. 8, 2018

(54) METHOD FOR CONNECTION FOR COST-EFFECTIVE CONTROL OF AN ELECTRONIC MOTOR

(71) Applicant: AMK ARNOLD MÜLLER GMBH & CO. KG, 73230 Kirchheim/Teck (DE)

(72) Inventor: Alfred GAUSE, Baltmannsweiler (DE)

(73) Assignee: AMK ARNOLD MÜLLER GMBH & CO. KG, 73230 Kirchheim/Teck (DE)

(21) Appl. No.: 15/563,630

(22) PCT Filed: Mar. 24, 2016
(86) PCT No.: PCT/EP2016/000523

§ 371 Date: Oct. 2, 2017

(30) Foreign Application Priority Data
Apr. 4, 2015 (DE) 10 2015 004 470.2

(51) Int. Cl. H02G 3/08; H02K 5/22

(52) U.S. Cl. CPC H02G 3/083; H02G 3/086; H02K 5/225

(57) ABSTRACT

A method is provided for connection for the cost-effective control of an electronic motor by single-cable technology having a high protection class, wherein the connector technology which is known per se is combined with the terminal box technology which is known per se, and the single cable is pre-assembled with connectors without a high protection class, and, with the terminal box of the electronic motor open, the connectors are inserted into the associated sockets, and the pre-assembled single cable is inlaid into a combined strain relief and earthing shell formed in the terminal box, and a terminal box base is firmly closed by a terminal box lid. By the screwing of the terminal box lid to the terminal box base, the connectors are held in position in their sockets in the terminal box, the connection produced by the connectors and sockets takes place in accordance with printed circuit board technology, and the single cable is a hybrid cable, in which the power supply, the electronic power supply and the communication are combined in one cable.

The invention relates to a connection method for inexpensive control of an electronic motor by means of single cable technology with high protection class, where the plug connector technology known per se is combined with the terminal box technology known per se, and the single cable is ready-made with plug connectors without high protection class, and the plug connectors are inserted, with the terminal box of the electronic motor opened, into associated sockets, and the ready-made single cable is placed into a combined strain relief and earthing shell provided in the terminal box, and a terminal box base is firmly closed with a terminal box cover.

Large areas of mechanical engineering need drive technology for movements in many ways. This activity is today performed mainly by electric motors. To control these electric servomotors, an electronic control unit is needed as a rule. The electronic control unit for variable and dynamic speed adjustment of these servomotors is here usually centrally accommodated in an electrical switch cabinet, from where the electric motors are operated using cable connections.

Increasingly however, electronic control is also being handled decentrally and additionally integrated into the electric motors. Due to the typical ambient conditions at their places of use, high protection classes, for example IPx5+, are required for the electronics and the motors. The connections in the case of these drive solutions therefore mainly use terminal box technology and PG screw connections or plug connections with high protection class. Both connection types have their advantages and disadvantages.

For example, plug connection technology is very expensive materials, whereas with terminal box solutions extensive wiring of possibly large numbers of leads must be performed as a rule, which is typically complex and error-prone.

Increasingly, single cable solutions with so-called hybrid cables are being used, in which the power supply, the electronics supply and the communication or control of the electric motors are brought together in one cable. The individual wiring of the individual conductors becomes even more complex as a result, and the plug connection becomes more expensive if a high protection class, for example IPx5+, has to be maintained.

In the prior art (DE 199 26 542 A1), different connection solutions in single cable connection technology are now known. The single cables used here have several conductors enclosed by an insulator in the form of a joint sheath. The individual conductors or leads combined in a single cable of this type are usually provided with their own sheaths for lead insulation, which are in turn enclosed by the cable sheath. As a rule, shielding is provided between the joint cable sheath and the individual insulated conductors. Shielding of this type, which can be designed in the form of a wire mesh, a braided net or a metal foil enclosing the conductor, then represents a protective conductor (TE conductor).

Shielding of this type is used to ensure the electromagnetic compatibility (EMC) of the cable. Shielding ensures that both electromagnetic fields acting on the cable from the outside and electromagnetic fields emanating from the cable are shielded such that these fields cannot cause any interference due to uncontrolled interaction with other devices, nor leak stray electromagnetic fields into these devices.

An electrical machine, in particular an electric motor, which has a connecting cable at least for supplying energy to said electrical machine, is known from DE 10 2006 046 049 A1. In the known solution, the connecting cable has at least one lead surrounded by a cable sheath and an exposed cable end. The electrical machine furthermore has at least one receptacle for strain relief of the connecting cable and one electrical connection for connecting the cable end. The connecting cable has, in the region of the cable end, a crimp flange with a flange sleeve which is inserted between the cable sheath and the at least one lead, and is crimped with a crimp sleeve pushed onto the cable sheath and over the flange sleeve. The crimp flange thus formed is placed, with the connecting cable fastened therein, into a receptacle. The known solution is complicated to manufacture and hence cost-intensive to implement.

Proceeding from the aforementioned prior art, the object of the invention is to reduce the costs of known connection technologies for controlling an electronic motor by means of single cables while maintaining a high protection class.

An object having that effect is achieved with the features of claim 1 in its entirety and within the framework of a claimed connection technology in accordance with the features embodied in claim 9. Further advantageous embodiments of the inventions are shown in the dependent claims.

Due to the facts that according to the characterizing part of plug connectors are kept in position in their sockets inside the terminal box by the screw connection of the terminal box cover to the terminal box base, that the connection resulting from plug connectors and sockets is based on printed circuit board technology, and that the single cable is a hybrid cable in which the power supply, the electronics supply and the communication are combined in one cable, the costs of known connection technologies for controlling an electric motor by means of single cables are reduced while maintaining a high protection class.

With the connection technology according to the invention, the single cables used are provided at their cable ends with contact devices, as a rule in the form of plugs, which are intended to be joined to a complementarily designed socket as a matching part and thus allow the individual conductors to be connected to other devices, for example printed circuit boards.

To do so, the contact devices consist of male and female contacts which are designed as contact pins and contact sockets respectively and can each be combined inside contact blocks of insulating plastic.

Details of the invention are described in more detail in the following, on the basis of an embodiment in conjunction with the associated drawings.

The drawings show in:

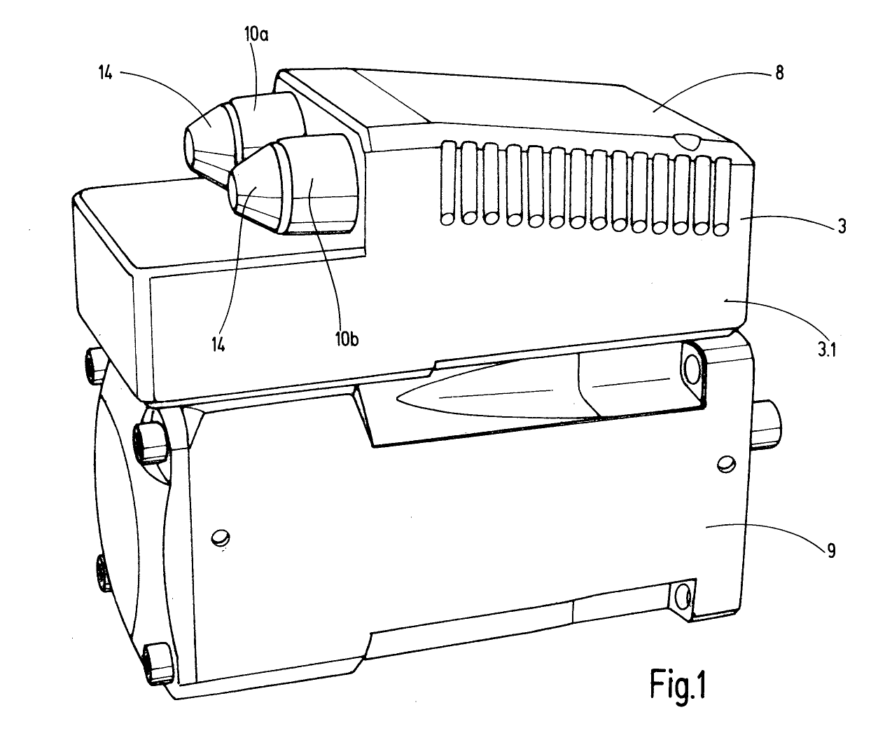

FIG. 1 a servomotor in a perspective side view with associated and attached connection housing;

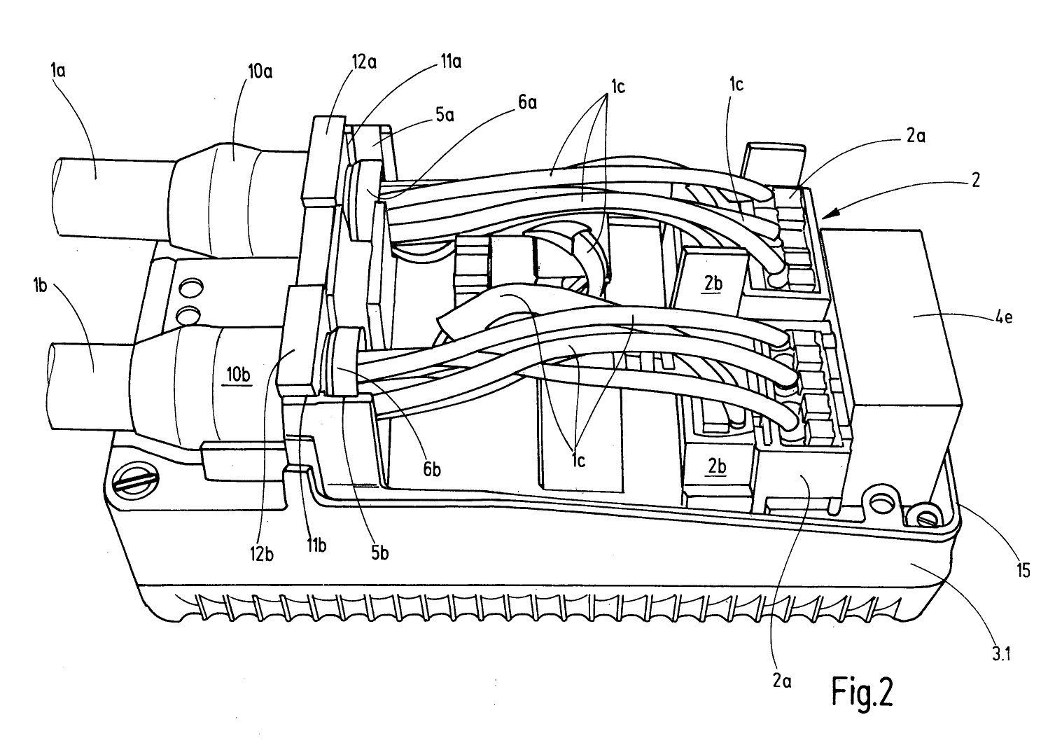

FIG. 2 the connection housing of FIG. 1 as a base without cover and with inserted cabling; and

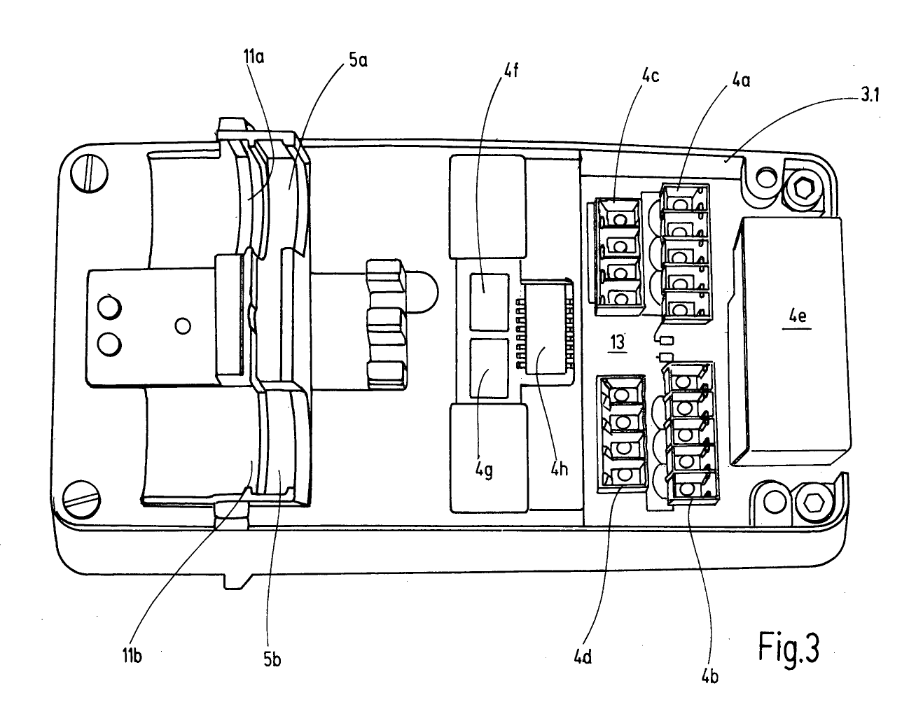

FIG. 3 a plan view of the base of the connection housing according to FIG. 2 without cabling.

The connection housing 3 shown in FIG. 1 is mounted on the top of a servomotor 9 and is connected thereto in the usual way. Furthermore, a standard electrical cable connection using individual cables, not shown in detail, exists between the servomotor 9 and the connection housing 3. The housing 3 is composed of a lower terminal box base 3.1 and an upper terminal box cover 8. On the one side of the connection housing 3, two cable inputs 10a and 10b are provided, each enabling a single cable 1a and 1b respectively (not shown in FIG. 1) to be passed into the interior of the connection housing 3.

At the cable inputs 10a and 10b (FIGS. 2 and 3), receptacles 11a and 11b plus 5a and 5b are provided in the terminal box base 3.1 and in corresponding manner in the terminal box cover 8, and are made up of a half-shell in the terminal box base 3.1 and a half-shell designed as a mirror image thereof in the terminal box cover 8, into which receptacles one each of the single cables 1a and 1b can be placed when the connection housing 3 is opened and can be fixed in clamping manner when the connection housing 3 is closed.

For this purpose, top parts 12a and 12b made of an elastomer plastic or another suitable plastic are integrally moulded onto the single cables 1a and 1b respectively, where the integrally moulded top parts 12a and 12b interact with the associated receptacles 11a and 11b respectively, or with the half-shells forming the receptacles, in a sealing manner and at the same time providing protection against kinks.

The second receptacles 5a and 5b, which are likewise made up of half-shells designed as mirror images in the terminal box base 3.1 and in the terminal box cover 8, receive one of the crimp sleeves 6a and 6b respectively. These crimp sleeves 6a and 6b are mechanically and electrically firmly compressed with the shielding of the single cables 1a and 1b respectively and simultaneously provide mechanical strain relief and continuous and gap-free shielding of the single cables 1a and 1b inside the connection housing 3, which for this purpose consists of an aluminium alloy made in a die-casting process or of die-cast zinc.

At the ends of the single cables 1a and 1b, at which the individual conductors 1c exit the sheaths of the single cables 1a, 1b, plug connectors 2 are attached and arranged inside plastic boxes 2a, 2b, which can be achieved inexpensively by means of pre-assembly (FIG. 2).

At the other end of the interior of the connection housing 3, a printed circuit board 13 manufactured by printed circuit board technology (FIG. 3) is fastened with first rows of sockets 4a and 4b, which are used for connection of the high-voltage supply (400 V to 800 V). Second rows of sockets 4c and 4d on the printed circuit board 13 provide the 24V low-voltage connection. Furthermore, a capacitor block 4e is inserted in the terminal box base 3.1 as well as field buses 4f and 4g electrically connectable in turn to the single cables 1a, 1b respectively, and an address switch 4h for selecting the respective field bus 4f or 4g. The configuration can be easily discerned in FIG. 3, since the cabling shown in FIG. 2 has not yet been inserted there.

The plug connections of low protection class ready-made with plugs are combined in plastic boxes 2a and 2b. Joining the plastic boxes 2a and 2b with the socket rows 4a, b and 4c, d respectively fastened on the printed circuit board 13 results, after fitting of the terminal box cover 8 onto the terminal box base 3.1 and screwing both parts together, in an inexpensive connection of a high protection class. The fitting and screwing of the terminal box cover 8 onto the terminal box base 3.1 keeps the plugs in the terminal box in position and at the same time achieves a high protection class of the overall arrangement 1 to 13.

In the connection housing 3 described above, further connections and switching elements with contactable connections (not shown) can be accommodated as required while maintaining a high protection class.

1-16. (canceled)

17. A connection method for inexpensive control of an electronic motor by single cable technology with high protection class, where the plug connector technology known per se is combined with the terminal box technology known per se, and the single cable is ready-made with plug connectors without high protection class, comprising
inserting the plug connectors, with the terminal box of the electronic motor opened, into associated sockets,
placing the ready-made single cable into a combined strain relief and earthing shell provided in the terminal box,
closing a terminal box base is with a terminal box cover,
keeping the plug connectors in position in their sockets inside the terminal box by a screw connection of the terminal box cover to the terminal box base, wherein a connection resulting from the plug connectors and the sockets is based on printed circuit board technology, wherein,
attaching and arranging the plug connectors inside plastic boxes at a 90° angle to a longitudinal extent of the single cable at an end of the single cable, at which individual conductors exit a sheath of the single cable, and
arranging a printed circuit board manufactured by printed circuit board technology with a first row of sockets for connection of a high-voltage supply (400 V to 800 V) and a second row of sockets, for connection of a 24V low-voltage supply, at an other end of the interior of the terminal box, the second row being closer to the combined strain relief and earthing shell, wherein the single cable is a hybrid cable in which the power supply, the electronics supply and the communication are combined in one cable.

18. The method according to claim 17, wherein the plug connections of low protection class ready-made with plugs are combined in plastic boxes.

19. The method according to claim 17, wherein the shielding of the single cable is compressed with an electrically conducting crimp sleeve and is placed therewith into the earthing shell provided on the terminal box.

20. The method according to claim 17, wherein the terminal box is designed electrically conducting.

21. The method according to claim 17, wherein a high protection class of the overall system is achieved by continuing the shielding of the single cable inside the terminal box.

22. The method according to claim 17, wherein the single cable is a hybrid cable.

23. The method according to claim 17, wherein a widespread printed circuit board technology is used.

24. A connection device in an electronic motor for connection of a single cable, comprising a split, metallic terminal box on an electronic motor for connection of the single cable designed as a hybrid cable in which the power supply, the electronics supply and the communication are combined in one cable and in which at the end of the single cable, at which individual conductors exit a sheath of the single cable, plug connectors are attached and arranged inside plastic boxes at a 90° angle to the longitudinal extent of the single cable, by at least one receptacle provided in the terminal box base and in the terminal box cover for at least one crimp sleeve mechanically and electrically connected to the shielding of the single cable, by a plurality of sockets in the terminal box into which ready-made plug connectors of the single cable are inserted, where at that end of the interior of the terminal box opposite the receptacles a printed circuit board manufactured by printed circuit board technology is arranged with a first row of sockets for connection of a high-voltage supply (400 V to 800 V) and a second row of sockets for connection of a 24V low-voltage supply, where the second row of sockets is closer to the combined strain relief and earthing shell than the first row of sockets, and where the plug connectors do not need to have a high protection class to achieve a high protection class of the overall system after the metallic terminal box cover has been firmly screwed to the metallic terminal box base, and where the plug connectors are kept in position inside their sockets in the terminal box by the screw connection of the terminal box cover to the terminal box base.

25. The connection device according to claim 24, wherein the plugs are held in position seated in the sockets inside the terminal box by the fitted terminal box cover.

26. The connection device according to claim 24, wherein by the interaction of the crimp sleeve of the single cable with the receptacle provided in the terminal box base and with the receptacle for the crimp sleeve provided as a mirror image thereof in the terminal box cover, earthing for the respective single cable is achieved in addition to continuous shielding when the terminal box cover is fitted.

27. The connection device according claim 24, wherein the electronic motor is equipped for decentralized control with integrated electronic unit.

28. The connection device according to claim 24, wherein the crimp sleeve consists of brass.

29. The connection device according to claim 24, wherein an elastomer top part is integrally moulded onto the single cable that interacts with the input-side access of the terminal box in a sealing manner in order to seal the terminal box.

30. The connection device according to claim 24, wherein the terminal box is sealed against the environment by an all-round seal between the terminal box base and the terminal box cover.

31. The connection device according to claim 24, wherein the terminal box with its components consists of die-cast aluminium or zinc.
